(19) United States
(12) Patent Application Publication
(10) Pub. No.: US 2010/0042448 A1
(43) Pub. Date: Feb. 18, 2010

(54) APPARATUS, AND ASSOCIATED METHOD, FOR EVALUATING ORGANIZATION BEHAVIOR USING ORGANIZATION ELECTRONIC COMMUNICATION

(75) Inventor: CHARLES BESS, MCKINNEY, TX (US)

Correspondence Address: HEWLETT-PACKARD COMPANY;Intellectual Property Administration, 3404 E. Harmony Road, Mail Stop 35, FORT COLLINS, CO, 80528, US

(73) Assignee: ELECTRONIC DATA SYSTEMS CORPORATION, PLANO, TX (US)

(21) Appl. No.: 12/191,436

(22) Filed: Aug. 14, 2008

(51) Int. Cl. G06Q 10/00

(52) U.S. Cl. 705/7

(57) ABSTRACT

An apparatus, and an associated methodology for evaluating organization behavior from electronic communications between members of an organization. The comparison determines whether a first group dominates a second group, whether a first person of a first group dominates said first group or whether a first person of a first group dominates said organization. An alert message is generated and transmitted if it is determined that communications indicate that organizational effectiveness is or might be effected by inappropriate communications.

The present invention relates generally to a manner by which electronic communications exchanged between members of an organization are collected and analyzed by a computer in order to determine the organization's effectiveness or health. The content and context of electronic communications are collected by one or more computers, analyzed and compared against pre-defined attributes and patterns of behavior that the organization is expected to have. One or more reports or alarms are issued by the computer when communications indicate that the organization does not conform to, or deviates from, the pre-defined attributes of the organization.

### BACKGROUND OF THE INVENTION

The Internet has enabled many different forms of electronic communications, examples of which include electronic mail or “email,” news groups and web logs or “blogs.” The Internet has also become nearly ubiquitous throughout the world.

A consequence of the Internet's global reach and ubiquitous presence has been to increase communications between people in an organization while reducing face-to-face meetings, which in the past provided opportunities for individuals from disparate organizations to communicate. Anecdotal evidence shows that some people will make statements in e-mail messages, or, on web logs, which they might not make to someone in a face-to-face meeting and which can be re-sent or forwarded endlessly. The Internet and the faceless electronic communications it fostered can therefore decrease effective communication and can decrease organizational effectiveness.

The ease with which e-mail, news groups, and web logs can be used in large organizations can have drawbacks. Organizations can claim that they are global in nature and yet have only a regional focus, as can happen when they become dominated by a small group or even an individual. Organizations or communities can become overwhelmed by likeminded personnel or individual “information bullies” that feed upon their own ideas and not allow other topics to be effectively discussed using electronic communications. Virtual organizations can be made “sick” through collaborative technologies without anyone really knowing that the organization is “ill” or how to correct and thereafter prevent offensive, intimidating, manipulative or other deleterious communications from being made.

It is in light of this background information related to electronic communications and organizational effectiveness that the significant improvements of the present invention have evolved.

### SUMMARY OF THE INVENTION

The present invention, accordingly, advantageously provides an apparatus, and an associated method, by which electronic communications between members of an organization can be monitored to determine whether the organization's communications comply with organizational guidelines or attributes, which can include one or more behaviors or behavior patterns Through operation of an embodiment of the present invention, a manner is provided by which to collect or receive attributes of an organization that can include expected or required behaviors in intra-organization communication. Intra-organization communications between individuals of an organization are collected, analyzed and compared to the intra-organization communication attributes and expected behaviors. Deviations from the expected or required behavior patterns or other attributes can cause one or more alarm messages to be generated, which can be sent to various individuals able to effectuate compliance of the organization's attributes.

In one aspect of the invention, the communications between individuals in different groups of an organization are collected, analyzed and measured to determine behavior, for example: whether the organization is dominated by a single group or whether a particular person or persons dominate a group or the organization. An alarm or other appropriate message is generated and sent to one or more individuals who are able to effectuate compliance with organization communication attributes.

In one embodiment, group communications that are monitored includes electronic mail, news group messages and web logs or “blogs” and “discussion threads.” For simplicity and brevity, the terms “email” and “e-mail” are used interchangeably herein to identify all forms of Internet-enabled communication, specifically including electronic mail, news groups, web logs, discussion threads, electronic workflow response and other electronically enabled collaboration techniques. In another embodiment, group communications that are monitored include conference call participation by one or more individuals.

In one aspect of the invention, email and conference call participation is monitored and information gathered about participation between individuals and groups of an organization that are located in different geographic regions. In another aspect, email and conference call participation is monitored between individuals and groups of an organization that perform different functions within the organization.

A more complete appreciation of the scope of the present invention and the manner in which it achieves the above-noted and other improvements can be obtained by reference to the following detailed description of presently-preferred embodiments taken in connection with the accompanying drawings that are briefly summarized below, and by reference to the appended claims.

### BRIEF DESCRIPTION OF THE DRAWINGS

FIG. 1 illustrates an apparatus for collecting electronic communications between members of an organization and for evaluating the communications for compliance with communication attributes required for the organization; and

FIG. 2 illustrates steps of a method by which electronic communication between members of an organization are collected and evaluated for compliance with communication attributes of the organization.

### DETAILED DESCRIPTION

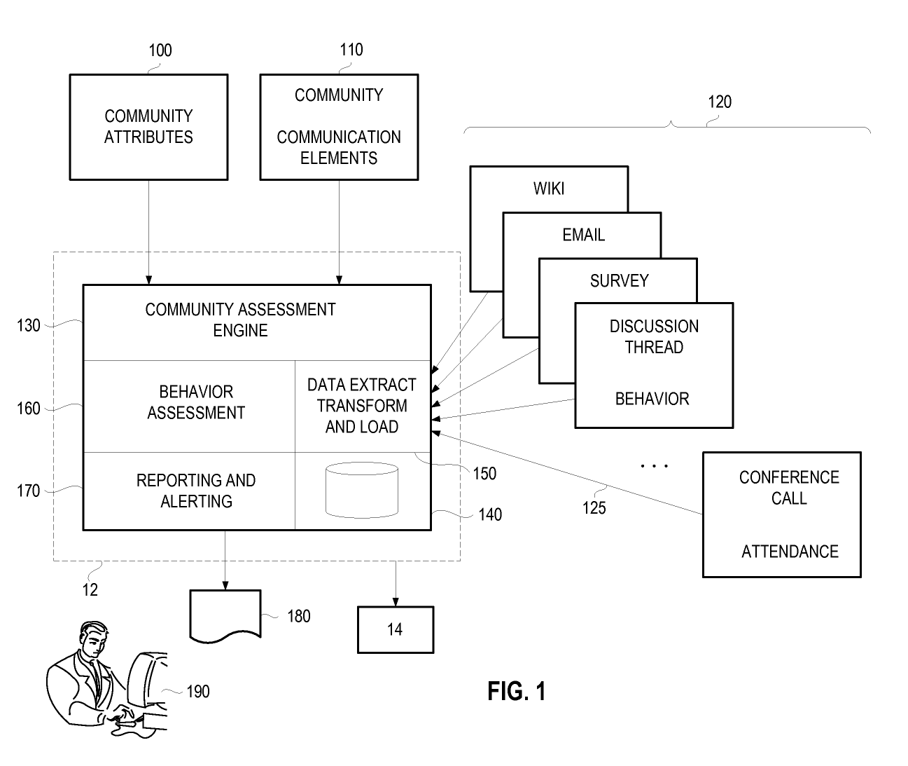

Referring first to FIG. 1, an apparatus, shown generally at 10, facilitates evaluating organization behavior from electronic communications between members of an organization. The elements of the apparatus 10 are functionally represented in the figures, but can be implemented in any desired manner, including, e.g., by algorithms executable by processing circuitry, hardware implementations such as a general purpose computer, and combinations thereof. Additionally, while the elements of the apparatus are shown together at a common physical location, in other implementations, the elements of the apparatus are distributed at more than one physical location.

As can be seen in FIG. 1, a computer device 12 is comprised of a communication assessment engine functional unit or “CAE” 130, which receives, or which has access to, a communication attribute database 100. The CAE 130 and its functionality can be implemented by the execution of computer program instructions stored in a memory device 14 operatively coupled to the computer 12. Examples of such a memory device include RAM, ROM, PROM, EEPROM as well as magnetic and optical storage disks. The CAE 130 can also be implemented by hardware, such as an application specific integrated circuit or ASIC, well known to those of ordinary skill in the art.

The communications attribute database 100 contains attributes or requirements of electronic communications for an organization and can also be stored in the memory device 14. The communication attribute database 100 can include global communication attributes, i.e., attributes for communications through-out or across an organization.

As used herein, a communication “attribute” can include certain key words and phrases, terms and phrases defined in the database as being obscene or offensive per se, racial, religious, gender or ethnic epithets or slurs, as well as certain characteristics of a communication, such as the use of bold faced or italicized text, underlined text. “Attribute” can also include certain idioms that an organization might use, object to or prohibit, but the presence of which in a communication indicates compliance with or violation of, an organization's expectations or norms for the behavior of its members. The term, “attribute” also includes a person designating an e-mail message as being urgent and/or using return receipts. The term, “attribute” also includes algorithms to derive patterns of behavior and implied or actual relationships in the use of collaborative communications techniques.

The communication attribute database 100 can also include communication attributes for one or more particular groups, functions or geographic locations or regions wherein parts of an organization operate or reside. Moreover, an organization, groups or functional units of an organization can themselves define or provide attributes to the communication attribute database 100.

Certain groups or subgroups might use words and phrases differently than other groups or subgroups might use them. Certain groups or subgroups might also use bold-faced text or return receipts more or less frequently that other groups or subgroups. In one embodiment, “attributes” as described above, can be specified in the database 100 for various different organizations, groups or subgroups thereof. Attributes can also be specified for various different regions or countries.

In addition to receiving communication attributes, the computer 12 also receives collaboration elements 110, which are also stored in the memory device 14. “Collaboration elements” include characteristics of communications between members of an organization.

Lastly, the various forms of intra-organization electronic communications 120 are intercepted or received by, forwarded or copied to the CAE unit, which can be readily accomplished by way of a network communication architecture that transmits all intra-network electronic communications to the CAE 130. As set forth above, electronic communications received by the CAE unit include, but are not limited to, electronic mail, news group messages and web logs or “blogs” and “discussion threads.” The terms, “email” and “e-mail” are used interchangeably herein to identify all forms of Internet-enabled communication, specifically including electronic mail, news groups, web logs, discussion threads, electronic workflow response and other electronically enabled collaboration techniques. As also set forth above, communications that are monitored by the CAE unit 130 include conference call participation by one or more individuals. An organization can intercept or monitor communications surreptitiously or openly as permitted by local law or as a matter of its own policy. Communications between members of an organization can be monitored by routing communications through a server or router, which then directs or copies the communications to the computer 12 depicted in FIG. 1.

Within the CAE, received communications are “normalized” 150 and stored in a database 140. The concept of “normalizing” a communication includes parsing a communication and determining a count of the occurrences of attributes that an organization defines a behavior (positive or negative). The number of occurrences is then divided by the size or length of a communication in words with the resultant fraction indicating a percentage of its content that is objectionable. Once the percentage of instances is determined, the communication can be flagged as warranting corrective action if the incidence level exceeds an organization-defined threshold or limit.

In a preferred embodiment, the database 140 is stored on a hard disk drive; however, alternate and equivalent embodiments contemplate storing the database on a portable disk drive or semiconductor memory.

Either as communications flow into the database 140, or on a periodic basis, the behavior of the entire organization, a group within the organization, a function of the organization, a location or region, is assessed against one or more of the attributes described above, which are stored in the communication attribute database 100. Assessments of the communications against the stored attributes are made by a behavior assessment module 160. The presence of objectionable attributes that are either over a certain number, or as a percentage of an e-mail message greater than a threshold, indicates that the communication is likely to be detrimental to the organization's health and/or effectiveness.

After the behavior of individuals is assessed by the behavior assessment module 160, and in order for the claimed apparatus and method to be effective, a status report or alarm is generated 180 by the computer 12, which is issued or forwarded by the computer 12 to one or more members of the organization or group, the communications of which were monitored. The report or alarm is sent to an individual authorized or empowered to effectuate a change in corporate communications.

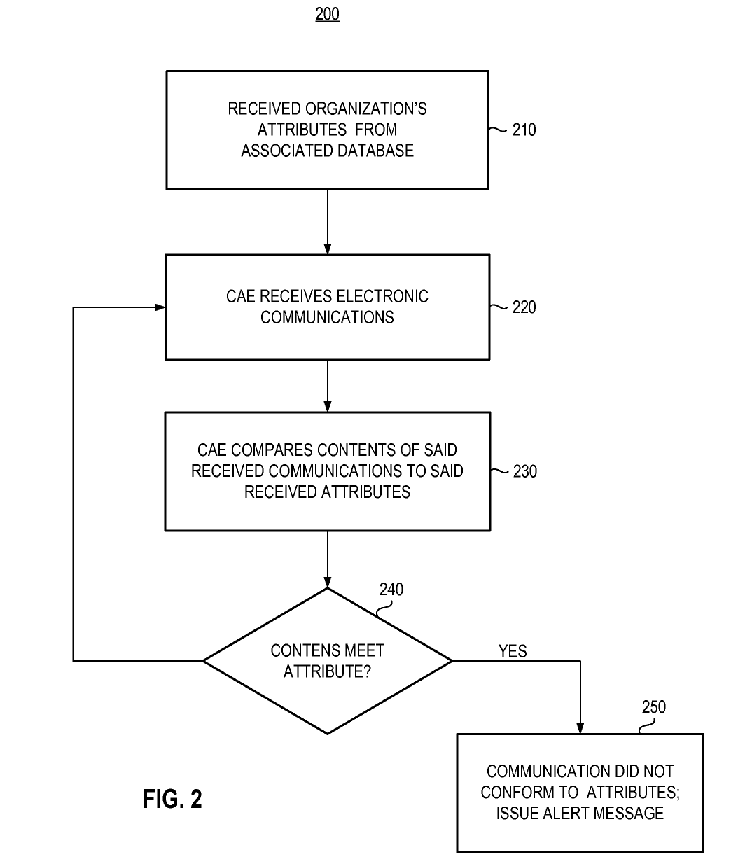

Referring now to FIG. 2 there is shown a flow chart that depicts steps of a method 200 by which electronic communication between members of an organization are collected and evaluated for compliance with communication attributes of the organization. In step 210, a CAE receives organization attributes, from an associated database. In step 220, the CAE receives one or more electronic communications sent from one member to another or, exchanged between members of the organization. In step 230, the CAE compares contents and metadata of said received communications to said attributes to determine compliance of the communication to the organization's attributes.

The comparison step 230 can include one or more different determinations. In one embodiment, the comparison step 230 determines whether a first group of an organization dominates or controls the organization itself or another group. In another embodiment, the comparison step 230 determines whether a particular person or persons dominate a group or the organization.

In step 240, the results of the comparison step 230 are used to determine whether an alert message is generated and transmitted to one or more members of the organization in step 230. Such an individual can thereafter take corrective steps to insure that electronic communications (e-mail, news group message, web logs and/or conference calls) do not hinder the organizations effectiveness and maximize value delivered. Thereafter, additional messages can be received and analyzed by having the program return to step 220 to compare a new message.

Presently preferred embodiments of the invention and many of its improvements and advantages have been described with a degree of particularity. The description is of preferred examples of implementing the invention and the description of preferred examples is not necessarily intended to limit the scope of the invention. The scope of the invention is defined by the following claims.

What is claimed is:

1. An apparatus for evaluating organization behavior from electronic communications between members of said organization, said apparatus comprising:
a computer having a community communications assessment engine (CAE) configured to:
receive organization attributes;
receive electronic communications between members of the organization;
compare contents of received communications to said attributes; and
generate an alert if said communications deviates from said attributes.

2. The apparatus of claim 1 wherein said organization is comprised of at least first and second groups, each group is comprised of at least one person, and wherein said CAE is configured to receive communications between said first and second groups.

3. The apparatus of claim 2, wherein said CAE is configured to determine whether a first group dominates a second group.

4. The apparatus of claim 2, wherein said CAE is configured to determine whether a first person of a first group dominates said first group.

5. The apparatus of claim 2, wherein said CAE is configured to determine whether a first person of a first group dominates said organization.

6. The apparatus of claim 3 wherein said electronic communications include at least one of:
electronic mail (email);
an electronic discussion thread;
a web log;
workflow response and
conference call participation.

7. The apparatus of claim 3 wherein said first and second groups are located in different geographic regions.

8. The apparatus of claim 3 wherein said first and second groups perform different functions within said organization.

9. The apparatus of claim 3 wherein said alert is distributed to a predetermined person associated with each group.

10. The apparatus of claim 3, wherein an attribute is comprised of at least one of:
a word;
a phrase;
an epithet;
derived pattern;
derived or actual personal network and
an idiom.

11. A computer storage media storing computer program instructions, which when executed cause a computer to:
receive organization attributes;
receive electronic communications between members of the organization;
compare contents of received communications to said attributes; and
generate an alert if said communications deviates from said attributes.

12. A method for evaluating organization behavior from electronic communications between members of an organization, said method comprising the steps of:
receiving organization attributes;
receiving electronic communications between members of the organization;
comparing contents of said received communications to said attributes; and
generating an alert if contents of said communications indicate a deviation from said attributes.

13. The method of claim 11 wherein said organization is comprised of at least first and second groups, each group being comprised of at least one person, and wherein said step of receiving communications includes the step of receiving communications between said groups.

14. The method of claim 12 wherein said step of comparing received communications includes the step of determining at least one of:
whether a first group dominates a second group;
whether a first person of a first group dominates said first group;
whether a first person of a first group dominates said organization.

15. The method of claim 13 wherein said electronic communications include electronic mail (email).

16. The method of claim 13 wherein said electronic communications include an electronic discussion thread.

17. The method of claim 13 wherein said electronic communications include a web log.

18. The method of claim 13 wherein said electronic communications include conference call participation.

19. The method of claim 13 wherein said electronic communications include electronic workflow response.

20. The method of claim 13 wherein said step of generating an alert is further comprised of the step of distributing said alert to a predetermined person associated with each group.
